(19) United States
(12) Patent Application Publication
(10) Pub. No.: US 2026/0252074 A1
(43) Pub. Date: Aug. 27, 2026

(54) VEHICLE CONTROL METHOD, DEVICE, AND STORAGE MEDIUM

(71) Applicant: PATEO CONNECT+ Technology (Shanghai) Corporation, Shanghai (CN)

(72) Inventor: Chen LIANG, Shanghai (CN)

(21) Appl. No.: 18/714,092

(22) PCT Filed: Dec. 16, 2021
(86) PCT No.: PCT/CN2021/138798

§ 371 Date: May 29, 2024

(30) Foreign Application Priority Data
Nov. 29, 2021 (CN) 202111448154.3

(51) Int. Cl. G05D 1/224; B60K 35/22; G05D 1/226

(52) U.S. Cl. CPC G05D 1/2244; B60K 35/22; G05D 1/226; B60K 2360/115

(57) ABSTRACT

The present disclosure describes a vehicle control method, an electronic device, and a computer-readable storage medium. The vehicle control method includes detecting a client mobile terminal within a predefined distance range of the vehicle; determining a location of the detected client mobile terminal relative to the vehicle and a client grade of the client mobile terminal; and based on the determined location and client grade, determining whether to send a notification message to the client mobile terminal to allow the client mobile terminal to provide a user interface to the user.

### CROSS-REFERENCE TO RELATED APPLICATION

This application claims priority to and the benefit of Chinese Patent Application No. 202111448154.3, filed on Nov. 29, 2021, the entire content of which is incorporated herein by reference.

### TECHNICAL FIELD

The present disclosure relates to the field of automotive technology and, more particularly, to a vehicle control method, device, and storage medium.

### BACKGROUND

In the traditional solution for controlling an onboard device, a driver or passenger needs to manually push the buttons on the onboard device to control the onboard device. However, with the continuous iterative updates of automobile technology, the functions of an onboard device have become increasingly diversified, resulting in an increasing number of buttons for controlling an onboard device to achieve different functions. If there are too many buttons on the onboard device, it directly affects the convenience of the driver or passenger in controlling the onboard device.

With the rapid development of Internet of Vehicles technology, the ways in which users interact with vehicles are becoming more and more diversified. Users may hope to interact with a vehicle in a more convenient way such as using mobile terminals to control the vehicle or implement information exchange.

### SUMMARY

An objective of the present disclosure is to provide a vehicle control method, electronic device, and computer-readable storage medium. By setting different client grades for mobile terminals and allowing mobile terminals of specific grades to control a vehicle device or query vehicle device information at a close distance, it provides a convenient and quick vehicle device control experience for vehicle owners and passengers. In addition, by granting different vehicle control permissions to mobile terminals with different client grades, it helps ensure the safety of vehicle control.

Another objective of the present disclosure is to provide a vehicle control method, electronic device, and computer-readable storage medium. By presenting a user with a vehicle-related option menu on a mobile terminal, it enables a user to conveniently browse and select a corresponding device on the vehicle based on an option menu, so as to obtain relevant information of the corresponding device or control the corresponding device, so that the user may conveniently control the vehicle device.

Another objective of the present disclosure is to provide a vehicle control method, electronic device, and computer-readable storage medium. By providing a user interface to a user within a predefined distance range of the vehicle, and by using an option menu to display options related to vehicle devices and associated queries, it allows a user to perform intuitive and convenient operations, and provides a user with a quick and convenient vehicle device control experience.

According to a first aspect of the present disclosure, a vehicle control method is provided. The method includes detecting a client mobile terminal within a predefined distance range of the vehicle and a client grade of the client mobile terminal, and based on the determined location and client grade, determining whether to send a notification message to the client mobile terminal to allow the client mobile terminal to provide a user interface to the user.

In some embodiments, determining whether to send a notification message to the client mobile terminal based on the determined location and client grade to allow the client mobile terminal to provide a user interface to the user includes, in response to determining that the client mobile terminal is outside or inside the vehicle and the client grade is the vehicle owner grade, sending a notification message to the client mobile terminal to allow the client mobile terminal to provide the user with a user interface that displays an option menu related to the vehicle.

In some embodiments, the method further includes receiving a query command or a control command input by the user after the user accesses an interface displaying the option menu through the user interface, and based on the query command or the control command, providing relevant information obtained based on the query command to the client mobile terminal, or control the vehicle to perform a corresponding action according to the control command.

In some embodiments, determining whether to send a notification message to the client mobile terminal based on the determined location and client grade to allow the client mobile terminal to provide a user interface to the user includes, in response to determining that the client mobile terminal is outside the vehicle and the client grade is not a vehicle owner grade, terminating communication with the client mobile terminal.

In some embodiments, determining whether to send a notification message to the client mobile terminal based on the determined location and client grade to allow the client mobile terminal to provide a user interface to the user includes, in response to determining that the client mobile terminal is inside the vehicle and the client grade is the owner grade or passenger grade, sending a notification message to the client mobile terminal to allow the client mobile terminal to provide the user with a user interface for accessing an interface displaying an option menu related to interior devices of the vehicle.

In some embodiments, the method further includes receiving a query command or a control command input by the user after the user accesses the interface displaying the option menu through the user interface, and based on the query command or the control command, providing relevant information obtained based on the query command to the client mobile terminal or controlling the vehicle to perform a corresponding action according to the control command.

In some embodiments, the method further includes providing an onboard display of a user interface to the user through a display device of the vehicle, in response to the user clicking the onboard display of the user interface, displaying an option menu related to interior devices of the vehicle, and based on the query command or control command input by the user on the interface displaying the option menu, feeding back to the user the relevant information obtained based on the query command, or performing a corresponding action according to the control command.

In some embodiments, detecting a client mobile terminal within a predefined distance range of the vehicle includes detecting a client mobile terminal within the predefined distance range of the vehicle based on near-field connection technology or Global Navigation Satellite System (GNSS) high-precision positioning technology, wherein the near-field connection technology includes at least one of Bluetooth connection technology, Ultra-Wide Band (UWB) connection technology, and Wi-Fi connection technology.

According to a second aspect of the present disclosure, a vehicle control method is also provided. The method includes receiving a query command or a control command from a client mobile terminal via a cloud server, determining a client grade of the client mobile terminal, and in response to determining that the client grade of the client mobile terminal is the vehicle owner grade, providing the client mobile terminal with relevant information obtained based on the query command or controlling the vehicle to perform a corresponding action according to the control command, or in response to determining that the client grade of the client mobile terminal is not the vehicle owner grade, terminating communication with the client mobile terminal.

According to a third aspect of the present disclosure, an electronic device is also provided, which includes at least one processor, and a memory communicatively coupled to the at least one processor, where the memory stores instructions that may be executed by the at least one processor. When the instructions are executed by the at least one processor, the at least one processor may execute the above-described methods of the present disclosure.

According to a fourth aspect of the present disclosure, there is also provided a non-transitory computer-readable storage medium on which machine-executable instructions are stored, where the machine-executable instructions when executed cause a machine to perform the above-described methods of the present disclosure.

According to a fifth aspect of the present disclosure, a method for controlling a vehicle based on a mobile terminal is also provided. The method includes determining that the mobile terminal is within a predefined distance range of the vehicle, and providing a user with a user interface through the mobile terminal, in response to the user clicking the user interface, presenting an option menu related to the vehicle to the user, and communicating with the vehicle based on the user's operation on the option menu, to obtain relevant information of a vehicle device or control the vehicle device.

In some embodiments, presenting the user with an option menu related to the vehicle includes determining that the mobile terminal is outside the vehicle and presenting the user with an option menu related to exterior devices of the vehicle.

In some embodiments, presenting the user with an option menu related to the vehicle includes determining that the mobile terminal is inside the vehicle and presenting the user with an option menu related to interior devices of the vehicle.

In some embodiments, communicating with the vehicle based on the user's operation on the option menu to obtain relevant information of a vehicle device or control the vehicle device includes communicating with the vehicle through near-field connection technology to obtain the relevant information of the vehicle device or to control the vehicle device, where the near-field connection technology includes at least one of Bluetooth connection technology, UWB connection technology, and Wi-Fi connection technology.

According to a sixth aspect of the present disclosure, an electronic device is also provided. The electronic device includes at least one processor and a memory communicatively coupled to the at least one processor, where the memory stores the instructions that may be processed by the at least one processor. When the instructions are executed by the at least one processor, the at least one processor may execute the methods according to the fifth aspect of the present disclosure.

According to a seventh aspect of the present disclosure, there is also provided a non-transitory computer-readable storage medium on which machine-executable instructions are stored, where the machine-executable instructions when executed cause a machine to perform the methods according to the fifth aspect of the present disclosure.

It should be understood that the content described in this section is not intended to identify key features or important features of the embodiments of the present disclosure, nor is it intended to limit the scope of the present disclosure. Other features of the present disclosure will become readily understood from the following description.

### BRIEF DESCRIPTION OF THE DRAWINGS

The foregoing and other advantages of embodiments of the present disclosure will become apparent from the following detailed description with reference to the accompanying drawings, which are intended to illustrate some embodiments of the present disclosure and not to limit the disclosure. In the accompanying drawings:

FIGS. 1A-1B respectively illustrate an exemplary system architecture configured for applying a vehicle control method, in accordance with embodiments of the present disclosure,

FIGS. 2-3D respectively illustrate a flowchart of a vehicle control method, in accordance with embodiments of the present disclosure,

FIG. 4 illustrates a flowchart of another vehicle control method, in accordance with embodiments of the present disclosure,

FIG. 5 illustrates a flowchart of a method for controlling a vehicle based on a mobile terminal, in accordance with embodiments of the present disclosure,

FIGS. 6A-7B respectively illustrate an interface of a mobile terminal, in accordance with embodiments of the present disclosure, and

FIG. 8 illustrates a block diagram of an electronic device, in accordance with embodiments of the present disclosure.

### DETAILED DESCRIPTION OF THE EMBODIMENTS

For a better understanding of the present disclosure, various aspects of the present disclosure will be described in more detail with reference to the accompanying drawings. It should be understood that these detailed descriptions are merely descriptions of some embodiments of the present disclosure and are not intended to limit the scope of the present disclosure by any means. Additionally, descriptions of features that are well-known in the art may be omitted for greater clarity and conciseness.

Throughout the drawings and the detailed description, like reference numbers refer to like elements. For purposes of clarity, illustration, and convenience, the drawings may not be drawn to scale, and the relative sizes, proportions, and depictions of elements in the drawings may be exaggerated.

It will also be understood that the terms “comprises,” “includes,” “has,” “includes,” and/or “comprises,” when used in this specification, indicate the presence of stated features, integers, steps, operations, elements and/or parts, but does not exclude the presence or addition of one or more other features, integers, steps, operations, elements, parts and/or groups thereof. In addition, when expressions such as “at least one of” appear before a list of listed features, these expressions modify the entire list of the listed features but do not just modify the individual element in the list. In addition, when describing embodiments of the present disclosure, the use of “may” means “one or more embodiments of the present disclosure.” Also, the term “exemplary” is intended to refer to an example or illustration.

Unless otherwise defined, terms (including technical and scientific terms) used herein have the same meaning as commonly understood by one of ordinary skill in the art. It should also be understood that terms (such as those defined in commonly used dictionaries) are to be construed to have a meaning consistent with their meaning in the context of the relevant technology, and will not be interpreted in an idealized or overly formal sense, unless expressly limited thereto.

Various aspects of the present disclosure will be described in more detail hereinafter with reference to the accompanying drawings.

In some related technologies, there are already examples of using smartphones to control different devices on a vehicle, for example, controlling different devices on a vehicle through mobile phone remote control technology or mobile phone's “one finger connection” technology. Although the mobile phone remote control solution allows vehicle owners to control some devices on a vehicle, it is limited by the unintuitive operating interfaces, which prevent vehicle owners from remotely controlling more devices on a vehicle. In addition, the remote control solution may only authorize a vehicle owner to control the vehicles, but the passengers cannot control different devices on the vehicle or read information through related applications. The mobile phone's “one finger connection” technology may achieve the location and directivity of a remote-controlled device by using the mobile phone's own Ultra Wide Band (UWB) multi-antenna positioning. However, this solution requires a mobile phone to have a special UWB multi-antenna structure, which greatly limits its standard application and popularity. In addition, the mobile phone's “one finger connection” technology may only be used in the near field, and the usage scenarios are thus relatively limited.

In order to at least partially solve one or more of the above problems and other potential problems, some embodiments of the present disclosure propose a vehicle control strategy. In this strategy, a vehicle detects a client mobile terminal within the vehicle's predefined distance range, and may determine whether to send a notification message to the client mobile terminal after determining the specific location and client grade of the client mobile terminal, so that the client mobile terminal may provide a user interface to the user. Through this solution, different vehicle control permissions may be granted to client mobile terminals with different user grades, which helps ensure the safety of vehicle control.

In addition, according to the solution of the present disclosure, a vehicle-specific option menu may be presented to a user through the mobile terminal, so that the user may conveniently browse and select a corresponding device on the vehicle based on the option menu, so as to obtain relevant information of the corresponding device or control the corresponding device. This allows a user to conveniently control a vehicle device. According to the vehicle control solution provided by the embodiments of the present disclosure, drivers and passengers may be provided with the ability to control vehicle devices quickly and conveniently. Drivers and passengers do not need to use physical buttons on the vehicle or virtual buttons on the device screen. Instead, the drivers and passengers may directly select from the vehicle-specific option menu presented on the mobile terminal to control a vehicle device or query vehicle device-related information.

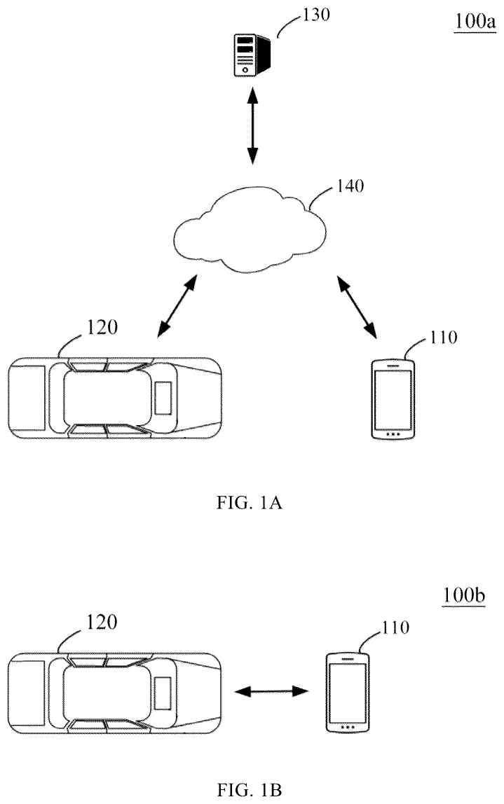

FIGS. 1A-1B respectively illustrate exemplary system architectures 100a and 100b configured for applying the method of controlling a vehicle based on a mobile terminal, according to some embodiments of the present disclosure.

As shown in FIGS. 1A and 1B, the system architecture may include a mobile terminal 110 and a vehicle 120. The mobile terminal 110 may include, but is not limited to, a smartphone, a smartwatch, a portable computer, a personal digital assistant, and the like. Various client applications may be installed on the mobile terminal 110, such as vehicle control applications, news applications, web browser applications, search applications, and so on.

Mobile terminal 110 may communicate with the vehicle 120 through various wired or wireless communication links. How mobile terminal 110 communicates with the vehicle 120 may depend, to a certain extent, on the distance of the mobile terminal 110 from the vehicle 120.

In the scenario shown in FIG. 1A, when the distance between the mobile terminal 110 and the vehicle 120 exceeds the detection range of the near-field connection technology, the mobile terminal 110 may communicate with the vehicle 120 via a wireless network 140. Wireless network 140 may include, but is not limited to, 2G networks, 3G networks, 4G networks, 5G networks, and the like. In some embodiments, both the mobile terminal 110 and the vehicle 120 may be connected to a cloud server 130 through the wireless network 140, so that a communication link between the mobile terminal 110 and the vehicle 120 may be established through the cloud server 130.

Cloud Server 130 may be a computing device that provides various services. Cloud server 130 may have one or more processing units, including dedicated processing units such as Graphics Processing Unit (GPU), Field Programmable Gate Array (FPGA), and Application Specific Integrated Circuit (ASIC), and general-purpose processing units such as Central Processing Unit (CPU). In some embodiments, the cloud server 130 may be implemented as a distributed server cluster composed of multiple cloud servers 130 or as a single cloud server 130.

In the scenario shown in FIG. 1B, when the distance between the mobile terminal 110 and the vehicle 120 does not exceed the detection range of the near-field connection technology, the mobile terminal 110 may communicate with the vehicle through the near-field connection technology. At this moment, the mobile terminal 110 may directly interact with an onboard server (for example, an onboard Telematics Box (T-BOX)). Near-field connection technology may include wireless near-field connection technology such as Bluetooth connection technology, UWB connection technology, Wi-Fi connection technology, etc., and wired near-field connection technology such as Universal Serial Bus (USB) connection technology and so on, which is not limited in the present disclosure.

It should be noted that when the distance between the mobile terminal 110 and the vehicle 120 is not greater than the detection range of the near-field connection technology, the mobile terminal 110 may communicate with the vehicle 120 through the near-field connection technology or communicate with vehicle 120 through the wireless network 140. In some embodiments, when the distance between the mobile terminal 110 and the vehicle 120 is no greater than the detection range of the near-field connection technology, the mobile terminal 110 may communicate with the vehicle 120 through the near-field connection technology and the wireless network 140 at the same time.

In some embodiments, the detection range of the near-field connection technology may be, for example, 10 meters. When the distance between the mobile terminal 110 and the vehicle 120 exceeds 10 meters, the mobile terminal 110 communicates with the vehicle 120 through cloud server 130 based on the wireless network 140. When the distance between the mobile terminal 110 and the vehicle 120 does not exceed 10 meters, the mobile terminal 110 may communicate with vehicle 120 via near-field connection technology and/or via wireless network 140. It should be understood that the detection range of the near-field connection technology provided here is only exemplary. In actual applications, the detection range of the near-field connection technology should depend on the effective distance of the specific near-field connection technology being used. As an example, the detection range of the near-field connection technology may be, for example, 1 meter, 2 meters, 5 meters, 15 meters, 20 meters, 25 meters, 30 meters, etc.

It should be understood that the numbers of mobile terminals 110, vehicles 120, and cloud servers 130 in FIGS. 1A-1B are merely illustrative. The system architecture may include any number of mobile terminals 110, vehicles 120, and cloud servers 130, based on actual needs.

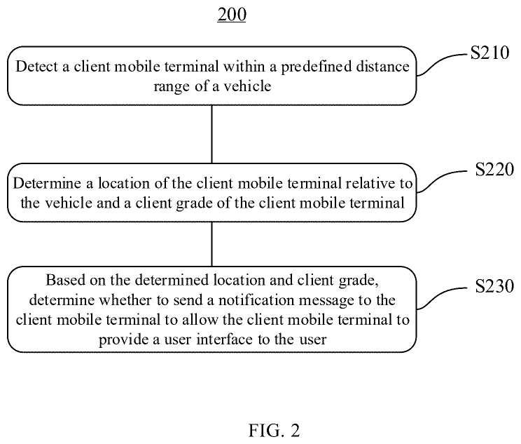

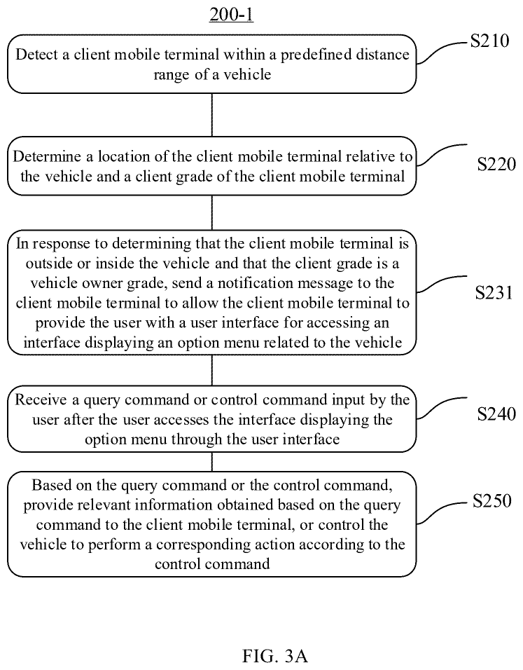

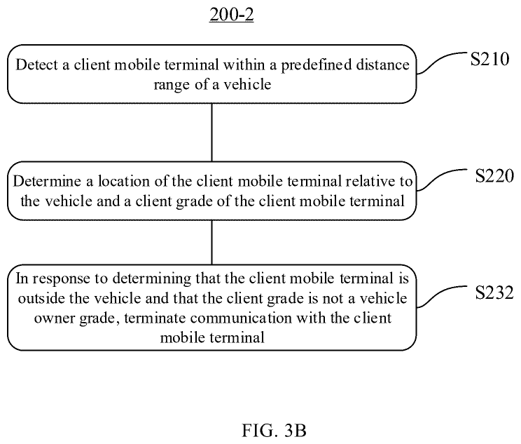

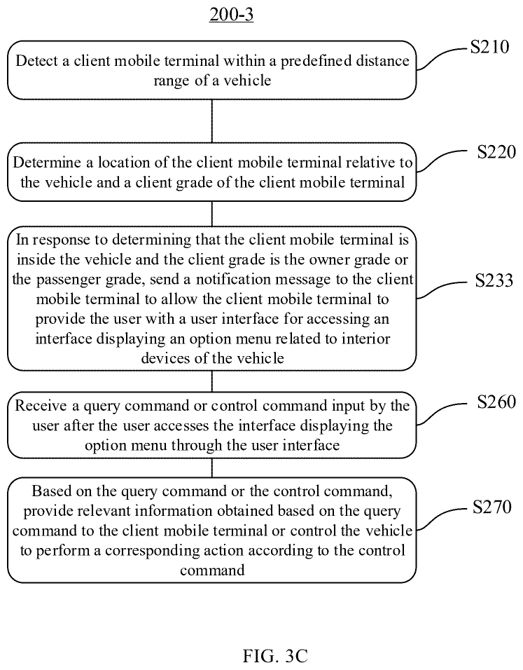

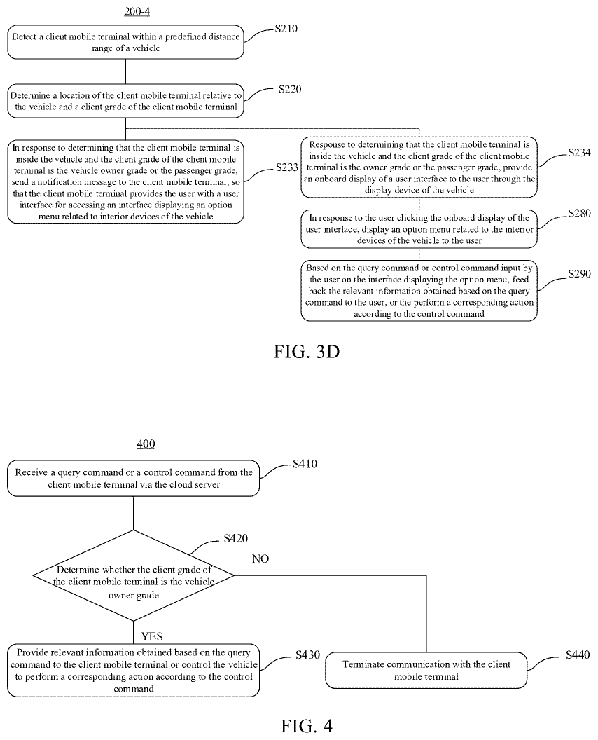

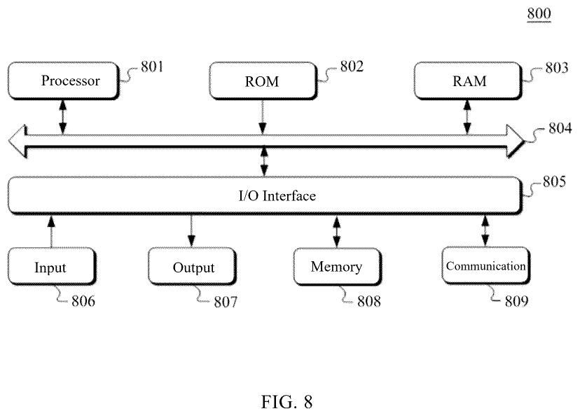

A vehicle control method according to embodiments of the present disclosure will be described hereinafter with reference to FIGS. 2-3D. FIGS. 2-3D respectively show a flowchart of a vehicle control method 200, 200-1, 200-2, 200-3, and 200-4 according to embodiments of the present disclosure. Methods 200, 200-1, 200-2, 200-3, and 200-4 may be executed, for example, at an onboard server of the vehicle 120 depicted in FIG. 1, or may be executed, for example, at an electronic device 800 depicted in FIG. 8. The following description takes an onboard server of the vehicle 120 as an example. It should be understood that methods 200, 200-1, 200-2, 200-3, and 200-4 may also include additional steps not shown and/or certain steps shown may be omitted, which is not limited in the present disclosure.

At Step S210, a client mobile terminal 110 within a predefined distance range of the vehicle 120 is detected. An onboard server mounted on the vehicle 120 may detect the client mobile terminal 110 within the predefined distance range of the vehicle 120 based on, for example, near-field connection technology. For example, whether the client mobile terminal 110 is within the predefined distance range of the vehicle 120 is determined based on the connection status between the client mobile terminal 110 and the vehicle 120. Exemplarily, the near-field connection technology may include at least one of Bluetooth connection technology, UWB connection technology, and Wi-Fi connection technology. In addition, Global Navigation Satellite System (GNSS) high-precision positioning technology may also be used to confirm whether the mobile terminal 110 is within the predefined distance range of the vehicle 120.

The predefined distance range of the vehicle may refer to a distance range that allows the use of near-field connection technology between the vehicle and the mobile terminal, that is, an effective distance range, centered around the vehicle, in which a near-field connection is established.

At Step S220, a location of the detected client mobile terminal 110 relative to the vehicle 120 and a client grade of the client mobile terminal 110 are determined. In some embodiments, the onboard server mounted on the vehicle 120 may determine the location of the mobile terminal 110 relative to the vehicle 120 through positioning technologies such as GNSS high-precision positioning technology, Bluetooth, or UWB. For example, the mobile terminal 110 may be outside the vehicle 120 or may be inside the vehicle 120. For example, through the high-precision positioning technology of the vehicle 120 and the high-precision positioning technology of the mobile terminal 110, it may be determined whether the mobile terminal 110 is inside or outside the vehicle when the mobile terminal 110 is within the predefined distance range of the vehicle 120. In addition, the onboard server may confirm the client grade of the client mobile terminal 110 by obtaining authentication information of the client mobile terminal 110.

In order to achieve the query or control function of a mobile terminal on a device on a specific vehicle, it is necessary to obtain a pre-authentication of the specific vehicle for the mobile terminal. When authenticating the mobile terminal, the mobile terminal needs to be within a predefined distance range of a specific vehicle. The mobile terminal communicates with the vehicle through wireless connection methods such as Bluetooth or UWB or through a wired connection method such as USB to obtain the pre-authentication by the vehicle. In this way, when the mobile terminal communicates with that specific vehicle again, the vehicle may determine whether to continue communicating with the mobile terminal by identifying whether the mobile terminal is an authenticated mobile terminal. If the vehicle recognizes that the mobile terminal is an authenticated mobile terminal, it may be allowed to continue communicating with the mobile terminal. Otherwise, the vehicle will terminate communication with the mobile terminal.

The authentication of the mobile terminal by the vehicle may include multiple user grades, such as owner grade and passenger grade. It should be understood that the authentication of the mobile terminal by the vehicle is not limited to the owner grade and passenger grade, but may also include other grades. For mobile terminals with different user grades, the permissions granted by the vehicle are different. For example, the vehicle may grant superior permission to a mobile terminal at the owner grade and general permission to a mobile terminal at the passenger grade. Superior permission may include, but is not limited to, allowing the mobile terminal to query or control interior and exterior vehicle devices through the vehicle control application when the mobile terminal is outside the predefined distance range of the vehicle, allowing the mobile terminal to query or control interior and exterior vehicle devices through the vehicle control application when the mobile terminal is within the predefined distance range of the vehicle and outside the vehicle, and allowing the mobile terminal to query or control interior and exterior vehicle devices through the vehicle control application when the mobile terminal is within the predefined distance range of the vehicle and inside the vehicle. General permission may include allowing the mobile terminal to query or control interior vehicle devices through the vehicle control application when the mobile terminal is within the predefined distance of the vehicle and is inside the vehicle, but not allowing the mobile terminal to query or control vehicle devices through the vehicle control application when the mobile terminal is outside the vehicle.

At Step S230, it is determined whether to send a notification message to the client mobile terminal 110 based on the determined location and client grade to allow the client mobile terminal 110 to provide a user interface to the user. The onboard server mounted on the vehicle 120 may determine whether communication with the client mobile terminal 110 needs to be continued based on the determined location information and the client grade.

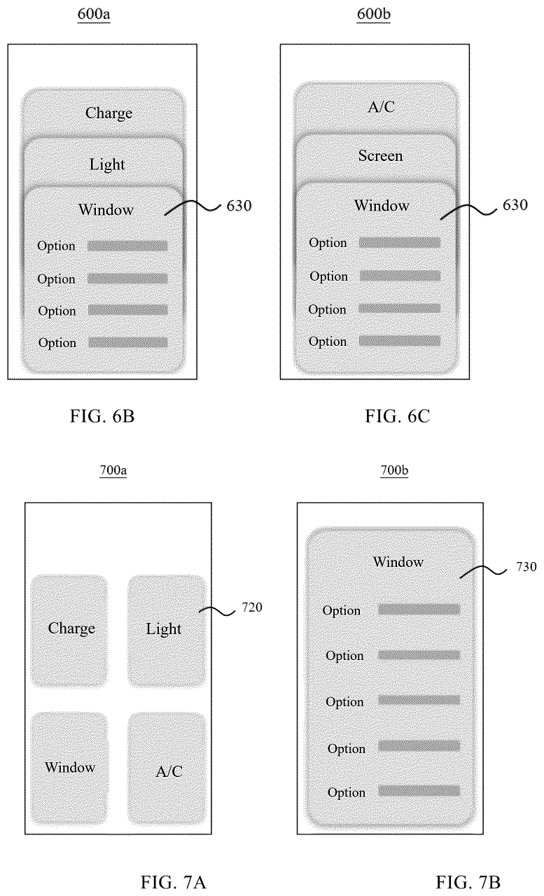

In some embodiments, Step S230 may be specifically implemented as Step S231, as shown in FIG. 3A. At Step S231, in response to determining that the client mobile terminal 110 is outside or inside the vehicle 120 and the client grade of the client mobile terminal 110 is the vehicle owner grade, a notification message is sent to the client mobile terminal 110 to allow the client mobile terminal 110 to provide the user with a user interface for accessing an interface displaying an option menu related to the vehicle 120 (such as the one shown at 620 in FIG. 6A). The notification message may include notification information authorizing the client mobile terminal 110 to provide a user interface to the user. In the case that the user has been pre-authorized, after receiving the notification message from the vehicle 120, the mobile terminal 110 may automatically pop up the user interface or the user to make selections.

In some embodiments, the vehicle control method according to embodiments of the present disclosure may further include Steps S240 and S250. At Step S240, a query command or control command input by the user through the user interface is received after the user accesses the interface displaying the option menu. Specifically, after the client mobile terminal 110 provides a user interface to the user, the user may view the option menu (such as the one shown at 630 in FIGS. 6B-6C, or the one shown at 720 in FIG. 7A) by clicking on the user interface, and make a selection on the option menu, that is, enter a query command or a control command. The query command or control command input by the user may be fed back to the vehicle 120 through the communication link between the client mobile terminal 110 and the vehicle 120, so that the vehicle 120 receives the query command or control command. At Step S250, the onboard server mounted on the vehicle 120 provides the client mobile terminal 110 with relevant information obtained based on the query command or controls the vehicle 110 to perform a corresponding action based on the control command. Optionally, when it is determined at Step S220 that the client grade of the client mobile terminal 110 is the vehicle owner grade and the client mobile terminal 110 is outside the vehicle 120, a menu option related to exterior devices outside the vehicle 120 may be provided to the user at Step S240. When it is determined at Step S220 that the client grade of the client mobile terminal 110 is the vehicle owner grade and the client mobile terminal 110 is inside the vehicle 120, an option menu related to interior devices inside the vehicle 120 may be provided to the client mobile terminal at Step S240.

In some embodiments, Step S230 may be specifically implemented as Step S232, as shown in FIG. 3B. At Step S232, in response to determining that the client mobile terminal 110 is outside the vehicle 120 and the client grade is not the vehicle owner grade, communication with the client mobile terminal 110 is terminated. For security reasons, different permissions are granted to the mobile terminals of users with different user grades, so that a user not at the vehicle owner grade cannot query the relevant devices of the vehicle or control the vehicle when the user is outside the vehicle.

In some embodiments, Step S230 may be specifically implemented as Step S233, as shown in FIG. 3C. At Step S233, in response to determining that the client mobile terminal 110 is inside the vehicle 120 and the client grade of the client mobile terminal 110 is the vehicle owner grade or the passenger grade, a notification message is sent to the client mobile terminal 110, so that the client mobile terminal 110 provides the user with a user interface (such as the one shown at 620 in FIG. 6A) for accessing an interface that displays an option menu related to the interior devices of the vehicle. The notification message may include notification information authorizing the client mobile terminal 110 to provide a user interface to the user. In the case that the user has been pre-authorized, the mobile terminal 110 may automatically pop up the user interface for the user to make selections after receiving the notification message from the vehicle 120.

In some embodiments, the vehicle control method according to embodiments of the present disclosure may further include steps S260 and S270. At Step S260, the query command or control command input by the user through the user interface is received after the user accesses the interface displaying the option menu. Specifically, after the client mobile terminal 110 provides a user interface to the user, the user may view the option menu related to the interior devices of the vehicle (such as the one shown as 630 in FIG. 6C) by clicking the user interface and making a selection related to an interior device of the vehicle on the option menu, that is, enter a query command or a control command. The query command or control command input by the user may be fed back to the vehicle 120 through the communication link between the client mobile terminal 110 and the vehicle 120, so that the vehicle 120 receives the query command or control command. At Step S270, the onboard server mounted on the vehicle 120 provides the client mobile terminal 110 with relevant information obtained based on the query command or controls the vehicle 110 to perform a corresponding action based on the control command.

In some embodiments, the vehicle control method according to embodiments of the present disclosure may further include Step S234 in parallel with Step S233, as shown in FIG. 3D. That is, after determining that the client mobile terminal 110 is inside the vehicle 120 and the client grade of the client mobile terminal 110 is the owner grade or the passenger grade, the vehicle 120 may send a notification message to the client mobile terminal 110 so that the client mobile terminal 110 provides the user with a user interface for accessing an interface that displays an option menu related to the interior devices of the vehicle. Meanwhile, the vehicle 120 may also provide an onboard display of a user interface to the user through the display device of the vehicle, as shown in Step S234. It should be understood that under certain circumstances, for example, if a user does not authorize the automatic pop-up function of the vehicle control application on the mobile terminal 110, the vehicle control method according to the present disclosure may only provide the user with the onboard display of a user interface through the display device of the vehicle 120.

At Step S280, in response to the user clicking the onboard display of the user interface, the display device of the vehicle 120 may display an option menu related to the vehicle's interior devices to the user. At Step S290, based on the query command or control command input by the user on the interface displaying the option menu, the vehicle 120 may feed back the relevant information obtained based on the query command to the user through the display device, or the vehicle 120 may perform a corresponding action according to the control command. In an example, the query command or control command input by the user on the interface displaying the option menu may be specifically a selection operation performed by the user on the option menu.

The vehicle control method according to embodiments of the present disclosure may grant a client mobile terminal that is inside the vehicle and whose client grade is the owner grade or passenger grade permission to view the interior vehicle device information or control the interior vehicle devices by viewing the option menu related to the interior vehicle devices, so as to meet the needs of a driver or a passenger to query or control the interior vehicle devices. The vehicle control method according to embodiments of the present disclosure enables the occupants to view interior vehicle device information or control the interior vehicle devices through the mobile terminal in the vehicle. This provides convenience for the occupants to control the interior vehicle devices inside the vehicle.

In addition, the vehicle control method according to embodiments of the present disclosure does not require a client mobile terminal to have a UWB multi-antenna structure, so the popularity of the application will not be restricted due to the requirement of a mobile terminal to have a UWB multi-antenna structure.

For an example of a user interface through which the mobile terminal 110 provides an interface displaying an option menu to the user, reference may be made to the interfaces 600, 600a, 600b, 700a, and 700b shown in FIGS. 6A-7B, respectively. As shown in FIG. 6A, the user interface 620 may be a pop-up window that pops up on the display area 610 of the mobile terminal 110. The presentation form of the pop-up window is not limited to the form shown in FIG. 6A, but may have various shapes and may be located at any location in the display area 610. A user may customize the shape of the pop-up window and its display location in the display area. By clicking on the user interface 620, a user may enter an interface displaying an option menu related to the vehicle, such as interface 600a, 600b, or 700a.

An option menu may include at least one of an overlay menu and a multi-level menu. FIGS. 6B-6C show examples of an overlay menu, and FIGS. 7A-7B show examples of a multi-level menu. In an example of a multi-level menu, a user may first access a first-level menu 720 as shown in FIG. 7A by clicking the user interface 620 or by activating the vehicle control program. After selecting an option in the first-level menu 720, the user may enter a second-level menu 730 as shown in FIG. 7B. It should be understood that the multi-level menu is not limited to the two levels of menus shown in FIGS. 7A-7B, but may be set to menus with any number of levels as desired.

In some embodiments, the option menu may be an option menu related to exterior vehicle devices (as shown in FIG. 6B) or an option menu related to interior vehicle devices (as shown in FIG. 6C). At an interface presenting a vehicle-related option menu, a user may enter a query command or a control command by clicking a corresponding option in the option menu.

A vehicle control method according to some embodiments of the present disclosure will be described hereinafter with reference to FIG. 4. FIG. 4 shows a flowchart of a vehicle control method 400 according to some embodiments of the present disclosure. The method 400 may be executed, for example, at an onboard server of the vehicle 120 depicted in FIG. 1, or may be executed, for example, at an electronic device 800 depicted in FIG. 8. The following description takes the onboard server of the vehicle 120 as an example. It should be understood that method 400 may also include additional steps not shown and/or steps shown may be omitted, which is not limited in the scope of the present disclosure.

At Step S410, the vehicle 120 receives a query command or a control command from the client mobile terminal 110 via the cloud server 140. At Step S420, the vehicle 120 determines whether the client grade of the client mobile terminal 110 is the vehicle owner grade. At Step S430, in response to determining that the client grade of the client mobile terminal 110 is the vehicle owner grade, relevant information obtained based on the query command is provided to the client mobile terminal 110 or the vehicle is controlled to perform a corresponding action according to the control command. At Step S440, in response to determining that the client grade of the client mobile terminal 110 is not the vehicle owner grade, communication with the client mobile terminal 110 is terminated.

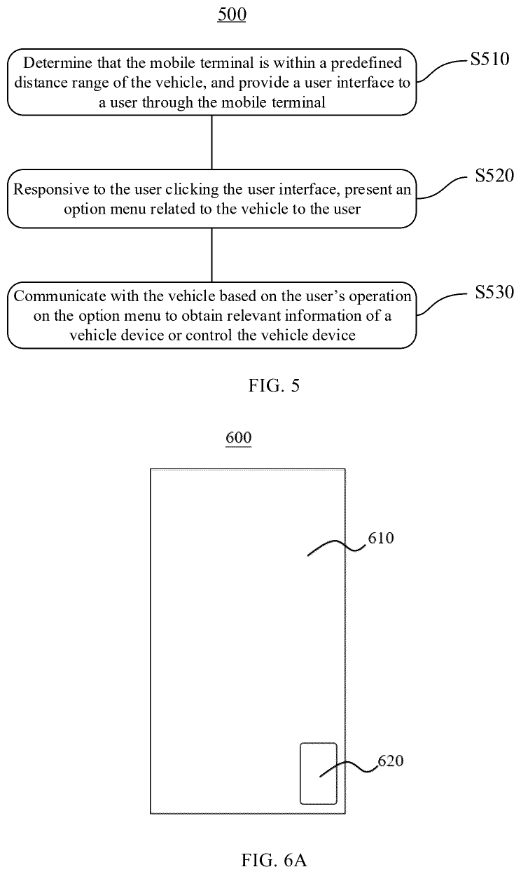

Another vehicle control method according to some embodiments of the present disclosure will be described hereinafter with reference to FIG. 5. FIG. 5 shows a flowchart of another method 500 for controlling the vehicle 120 through the mobile terminal 110 according to some embodiments of the present disclosure. The method 500 may be executed, for example, at the mobile terminal 110 illustrated in FIG. 1, or may be executed, for example, at an electronic device 800 illustrated in FIG. 8. The following description takes the mobile terminal 110 as an example. It should be understood that method 500 may also include additional steps not shown and/or steps shown may be omitted, which is not limited in the scope of the present disclosure.

At Step S510, it is determined that the mobile terminal 110 is within a predefined distance range of the vehicle 120, and thus a user interface is provided to the user at the mobile terminal 110 (such as the one shown as 620 in FIG. 6A). The predefined distance range of the vehicle may refer to a distance range that enables the function of near-field connection technology between the vehicle and the mobile terminal, that is, an effective distance range, centered around the vehicle, in which a near-field connection is established. In one example, the user interface provided to the user may be a pop-up window of an applet or a microservice, but the present disclosure is not limited thereto.

Depending on the distance between the mobile terminal 110 and the vehicle 120 and the relative locational between the mobile terminal 110 and the vehicle 120, the specific implementation in which the mobile terminal 110 presents an option menu related to the vehicle 120 to the user is different. Specifically, the implementation may be divided into two situations: the mobile terminal 110 is within the predefined distance range of the vehicle, and the mobile terminal 110 is outside the predefined distance range of the vehicle 120. The situation when the mobile terminal 110 is within the predefined distance range of the vehicle 120 may be further refined. There are two related situations: the mobile terminal 110 is outside the vehicle 120, and the mobile terminal 110 is inside the vehicle 120.

In some embodiments, whether the mobile terminal 110 is within the predefined distance range of the vehicle 120 may be determined by checking whether the mobile terminal 110 establishes a connection with the vehicle 120 through near-field connection technology. The near-field connection technology may include, for example, at least one of Bluetooth connection technology, UWB connection technology, and Wi-Fi connection technology. In addition, GNSS high-precision positioning technology may also be used to confirm whether the mobile terminal 110 is within the predefined distance range of the vehicle 120. Further, using positioning technologies such as GNSS high-precision positioning, Bluetooth or UWB, the location of the mobile terminal 110 relative to the vehicle 120 may be also determined. For example, it may be determined whether the mobile terminal 110 is outside the vehicle 120 or the mobile terminal 110 is inside the vehicle 120.

In some embodiments, when the mobile terminal 110 is outside the predefined distance range of the vehicle 120, a user may actively activate the vehicle control application on the mobile terminal 110 to view an option menu related to the vehicle. Specifically, the user may choose to view an option menu related to interior devices of the vehicle, or choose to view an option menu related to exterior devices of the vehicle. In some embodiments, the user may also choose to view an option menu related to all of the devices of the vehicle. The option menu may be embodied as at least one of an overlay menu and a multi-level menu.

At Step S520, in response to the user clicking the user interface, the mobile terminal 110 presents an option menu related to the vehicle 120 to the user. In some embodiments, when the mobile terminal 110 is determined to be outside the vehicle 120, the mobile terminal 110 may present an option menu related to exterior devices of the vehicle 120 to the user. In some embodiments, when the mobile terminal 110 is determined to be inside the vehicle 120, the mobile terminal 110 may present an option menu related to the interior devices of the vehicle 120 to the user. The vehicle control method provided according to embodiments of the present disclosure uses an option menu to display vehicle devices and related query options, so that a user may perform intuitive and convenient operations. This provides users with a quick and convenient vehicle device control experience.

Exemplarily, the option menu presented to a user by the mobile terminal 110 may change according to the location of the mobile terminal 110 with respect to the vehicle 120. Specifically, when the mobile terminal 110 is outside the vehicle 120, the mobile terminal 110 may present to the user an option menu related to the exterior devices of the vehicle 110. When the mobile terminal 110 is inside the vehicle 120, the mobile terminal 110 may present to the user an option menu related to the interior devices of the vehicle 110. For example, when it is determined that the mobile terminal 110 moves from the outside of the vehicle 120 to the inside of the vehicle 120, the option menu presented to the user by the mobile terminal 110 will be switched from an option menu related to the exterior devices of the vehicle 120 to an option menu related to the interior devices of the vehicle 120. Similarly, when it is determined that the mobile terminal 110 moves from the inside of the vehicle 120 to the outside of the vehicle 120, the option menu presented to the user by the mobile terminal 110 will be switched from an option menu related to the interior devices of the vehicle 120 to an option menu related to the exterior devices of the vehicle 120.

At Step S530, the mobile terminal 110 may communicate with the vehicle 120 based on the user's operation on the option menu to obtain relevant information of a vehicle device or control a vehicle device. The mobile terminal 110 may communicate with the vehicle 120 to send a user query to the vehicle 120. After receiving the relevant query, the vehicle 120 may feed back the relevant information requested by the user to the mobile terminal 110 or control the corresponding device based on the user query. In some embodiments, the vehicle 120 may feed back the operating status information of the corresponding device to the mobile terminal 110 after performing the relevant operation, so as to present the operating status of the device to the user.

In some embodiments, when the mobile terminal 110 is within the predefined distance range of the vehicle 120, the mobile terminal 110 may directly communicate with the vehicle 120 through near-field connection technology to obtain relevant information of the selected device or to control the selected device. Alternatively, when the mobile terminal 110 is within the predefined distance range of the vehicle 120, the mobile terminal 110 may also be connected to the cloud server 130 through the wireless network 140 to establish a communication link between the mobile terminal 110 and the vehicle 120 through the cloud server 130. This allows the mobile terminal 110 to obtain the relevant information of the selected device or control the selected device via the communication link.

In some embodiments, when the mobile terminal 110 is outside the predefined distance range of the vehicle 120, the mobile terminal 110 may be connected to the cloud server 130 through the wireless network 140 to establish a communication link between the mobile terminal 110 and the vehicle 120 through the cloud server 130. This allows the mobile terminal 110 to obtain relevant information of a selected device or control the selected device via the communication link.

The mobile terminal-based vehicle control method according to embodiments of the present disclosure provides a quick and convenient vehicle control experience to users. For example, when a user is located at a greater distance away from the vehicle (for example, the distance from the vehicle exceeds the predefined distance of the vehicle), the user may view an option menu related to the vehicle's interior and exterior devices through a vehicle control application on the mobile terminal. The user may select the corresponding option on the option menu to learn about the devices inside and outside the vehicle or to control the devices inside and outside the vehicle. When the user is close to the vehicle (for example, the distance to the vehicle is less than the predefined distance of the vehicle), the mobile terminal may provide the user with a user interface for viewing an option menu related to the vehicle. The user may learn about the information of a vehicle device or control a vehicle device by clicking the corresponding option in the option menu. As an example, the user may view the tire pressure of the vehicle by clicking on the View Tires option, or view the battery level of the vehicle by clicking on the View Charging Port option, etc. When the user is inside the vehicle, the user may control or view the information of a device in the vehicle by clicking the corresponding option on the option menu. Especially when there is no corresponding button on a vehicle device, this method may be used to quickly and conveniently view the device information or control the device.

FIG. 8 illustrates a block diagram of an electronic device (or computing device) 800 configured for implementing embodiments of the present disclosure. The device 800 may be a device for implementing the various methods described in FIGS. 2-5. As shown in FIG. 8, the device 800 includes a processor 801 that may operate in accordance with computer program instructions stored in a Read-Only Memory (ROM) 802 or loaded from a storage unit 808 into a Random Access Memory (RAM) 803, to perform various appropriate steps and processes. In the RAM 803, various programs and data required for the operation of the device 800 may also be stored. The processor 801, ROM 802, and RAM 803 are connected to each other through a bus 804. An Input/Output (I/O) interface 805 is also connected to bus 804.

Multiple components in the device 800 are connected to the I/O interface 805, including input unit 806 (such as a keyboard, mouse, etc.), output unit 807 (such as various types of displays, speakers, etc.), memory 808 (such as a magnetic disk, optical disk, etc.), and a communication unit 809 (such as a network card, modem, wireless communication transceiver, etc.). The communication unit 809 allows the device 800 to exchange information/data with other devices through computer networks such as the Internet and/or various telecommunication networks.

Processor 801 may be a variety of general and/or special-purpose processing components having processing and computing capabilities. Some examples of the processor 801 include, but are not limited to, a CPU, a GPU, various specialized Artificial Intelligence (AI) computing chips, various processors running machine learning model algorithms, Digital Signal Processing (DSP) processor, and any appropriate processor, controller, microcontroller, etc. The processor 801 may perform various methods and processes described above, such as methods 200, 200-1, 200-2, 200-3, 200-4, 400, and 500. For example, in some embodiments, methods 200, 200-1, 200-2, 200-3, 200-4, 400, and 500 may be implemented as computer software programs, which are stored in a machine-readable medium, such as a storage unit 808. In some embodiments, part or all of the computer program may be loaded and/or installed onto device 800 via ROM 802 and/or communication unit 809. When the computer program is loaded into RAM 803 and executed by the processor 801, one or more steps of methods 200, 200-1, 200-2, 200-3, 200-4, 400, and 500 described above may be performed. Alternatively, in some embodiments, the processor 801 may be configured to perform one or more steps of methods 200, 200-1, 200-2, 200-3, 200-4, 400, and 500 in any other suitable manner (e.g., by means of firmware).

It should be further noted that the present disclosure may include methods, devices, systems, and/or computer program products. A computer program product may include a computer-readable storage medium having thereon computer-readable program instructions for performing various aspects of the present disclosure.

Computer-readable storage media may be tangible devices that may retain and store instructions for use by an instruction execution device. The computer-readable storage medium may be, for example, but not limited to, an electronic storage device, a magnetic storage device, an optical storage device, an electromagnetic storage device, a semiconductor storage device, or any suitable combination of the above. More specific examples (non-exhaustive list) of computer-readable storage media include portable computer disks, hard disks, random access RAM, ROM, Erasable Programmable Read-Only Memory (EPROM), flash memory, Static Random Access Memory (SRAM), Compact Disk Read Only Memory (CD-ROM), Digital Versatile Disk (DVD), memory stick, floppy disk, mechanically encoded device such as punched cards and protruding structures in grooves with instructions stored thereon, and any suitable combination of thereof. As used herein, computer-readable storage media is not to be construed as referring to transient signals per se, such as radio waves or other freely propagating electromagnetic waves, electromagnetic waves propagating through waveguides or other transmission media (e.g., light pulses through fiber optic cables), or through electrical signals transmitted by wires.

The computer-readable program instructions described herein may be downloaded from a computer-readable storage medium to various computing/processing devices, or to an exterior computer or exterior storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage on a computer-readable storage medium in the respective computing/processing device.

Computer program instructions for performing the operations of the present disclosure may be assembly instructions, Instruction Set Architecture (ISA) instructions, machine instructions, machine-related instructions, microcode, firmware instructions, state setting data, or instructions in one or more programming languages, source code or object code written in any combination of object-oriented programming languages such as Smalltalk, C++, etc., and conventional procedural programming languages such as C or similar programming languages. The computer-readable program instructions may execute entirely on a user's computer, partly on the user's computer, as a stand-alone software package, partly on the user's computer and partly on a remote computer or entirely on the remote computer or server. In situations involving remote computers, the remote computer may be connected to the user's computer through any kind of network, including a Local Area Network (LAN) or a Wide Area Network (WAN). Or the remote computer may be connected to an exterior computer (such as an Internet service provider through the Internet). In some embodiments, by utilizing state information of computer-readable program instructions to personalize an electronic circuit, such as a programmable logic circuit, an FPGA, or a Programmable Logic Array (PLA), the electronic circuit may execute computer-readable program instructions to implement various aspects of the present disclosure.

Various aspects of the present disclosure are described herein with reference to flowchart illustrations and/or flow diagram illustrations of methods, apparatus (systems), and computer program products according to example embodiments of the present disclosure. It will be understood that each step of the flowchart illustrations and/or flow diagram illustrations, and combinations of steps in the flowchart illustrations and/or flow diagram illustrations, may be implemented by computer-readable program instructions.

These computer-readable program instructions may be provided to a processor in a voice interaction device, a general-purpose computer, a special-purpose computer, or a processing unit of other programmable data processing devices, thereby producing a machine such that these instructions may be processed by a computer or other programmable data processing device. The processing units of the data processing apparatus, when executed, produce means for implementing the functions/steps specified in one or more of the flowcharts and/or flow diagrams. These computer-readable program instructions may also be stored in a computer-readable storage medium. These instructions cause the computer, programmable data processing device, and/or other device to work in a specific manner. Therefore, the computer-readable medium storing the instructions includes an article of manufacture that includes instructions for implementing various aspects of the functions/steps specified in one or more steps of the flowcharts and/or flow diagrams.

Computer-readable program instructions may also be loaded onto a computer, other programmable data processing apparatus, or other device, causing a series of operating steps to be performed on the computer, other programmable data processing apparatus, or other device to produce a computer-implemented process, thereby causing instructions executed on a computer, other programmable data processing apparatus, or other device to implement the functions/steps specified in one or more steps of the flowcharts and/or flow diagrams.

The flowcharts and flow diagrams in the figures illustrate the architecture, functionality, and operation of possible implementations of apparatus, methods, and computer program products according to various embodiments of the present disclosure. In this aspect, each step in the flowcharts or flow diagrams may represent a module, segment, or portion of instructions that contains one or more operable functions for implementing the specified logical function. In some alternative embodiments, the functions noted in the steps may occur out of the order noted in the figures. For example, two consecutive steps may actually be performed substantially in parallel, or they may sometimes be performed in reverse order, depending on the functionality involved. It is also noted that each step of the flow diagram illustrations and/or flowchart illustrations, and combinations of steps in the flow diagram illustrations and/or flowchart illustrations, may be implemented by special-purpose hardware-based systems that perform the specified functions or actions or may be implemented using a combination of specialized hardware and computer instructions.

The foregoing description is merely some embodiments of the present disclosure and an explanation of the technical principles used. Persons skilled in the art should understand that the scope involved in the present disclosure is not limited to technical solutions formed by a specific combination of the above technical features, but should also cover any combination of the above technical features or other technical solutions formed by any combination of equivalent features without departing from the concept of the present disclosure. For example, a technical solution is formed by replacing the above features with technical features with similar functions disclosed in the present disclosure (but not limited to).

1. A vehicle control method, comprising:
detecting a client mobile terminal within a predefined distance range of a vehicle;
determining a location of the client mobile terminal relative to the vehicle and a client grade of the client mobile terminal; and
based on the determined location and client grade, determining whether to send a notification message to the client mobile terminal to allow the client mobile terminal to provide a user interface to the user.

2. The method according to claim 1, wherein, based on the determined location and client grade, determining whether to send a notification message to the client mobile terminal to allow the client mobile terminal to provide a user interface to the user comprises:
in response to determining that the client mobile terminal is outside or inside the vehicle and that the client grade is a vehicle owner grade, sending a notification message to the client mobile terminal to allow the client mobile terminal to provide the user with a user interface for accessing an interface displaying an option menu related to the vehicle.

3. The method according to claim 2, further comprising:
receiving a query command or control command input by the user after the user accesses the interface displaying the option menu through the user interface; and
based on the query command or the control command, providing relevant information obtained based on the query command to the client mobile terminal, or controlling the vehicle to perform a corresponding action according to the control command.

4. The method according to claim 1, wherein, based on the determined location and client grade, determining whether to send a notification message to the client mobile terminal to allow the client mobile terminal to provide a user interface to the user comprises:
in response to determining that the client mobile terminal is outside the vehicle and that the client grade is not a vehicle owner grade, terminating communication with the client mobile terminal.

5. The method according to claim 1, wherein, based on the determined location and client grade, determining whether to send a notification message to the client mobile terminal to allow the client mobile terminal to provide a user interface to the user comprises:
in response to determining that the client mobile terminal is inside the vehicle and the client grade is the owner grade or the passenger grade, sending a notification message to the client mobile terminal to allow the client mobile terminal to provide the user with a user interface for accessing an interface displaying an option menu related to interior devices of the vehicle.

6. The method according to claim 5, further comprising:
receiving a query command or control command input by the user after the user accesses the interface displaying the option menu through the user interface; and
based on the query command or the control command, providing relevant information obtained based on the query command to the client mobile terminal or controlling the vehicle to perform a corresponding action according to the control command.

7. The method according to claim 5, further comprising:
providing an onboard display of a user interface to the user through a display device of the vehicle;
displaying an option menu related to interior devices of the vehicle in response to the user clicking the onboard display of the user interface; and
based on the query command or control command input by the user on the interface displaying the option menu, feeding back to the user relevant information obtained based on the query command, or performing a corresponding action according to the control command.

8. The method according to claim 1, wherein detecting a client mobile terminal within a predefined distance range of the vehicle comprises:
detecting the client mobile terminal within the predefined distance range of the vehicle based on near-field connection technology or Global Navigation Satellite System (GNSS) high-precision positioning technology, wherein the near-field connection technology includes one or more of Bluetooth connection technology, Ultra-Wide Band (UWB) connection technology, or Wi-Fi connection technology.

9. (canceled)

10. An electronic device, comprising:
at least one processor; and
a memory communicatively coupled to the at least one processor, the memory storing instructions executable by the at least one processor, where the instructions, when executed by the at least one processor, cause the at least one processor to perform a vehicle control method comprising:
detecting a client mobile terminal within a predefined distance range of a vehicle:
determining a location of the client mobile terminal relative to the vehicle and a client grade of the client mobile terminal; and
based on the determined location and client grade, determining whether to send a notification message to the client mobile terminal to allow the client mobile terminal to provide a user interface to the user.

11. A non-transitory computer-readable storage medium storing machine-executable instructions, which when executed, cause a machine to perform a vehicle control method comprising:
detecting a client mobile terminal within a predefined distance range of a vehicle;
determining a location of the client mobile terminal relative to the vehicle and a client grade of the client mobile terminal; and
based on the determined location and client grade, determining whether to send a notification message to the client mobile terminal to allow the client mobile terminal to provide a user interface to the user.

12-17. (canceled)

18. The electronic device according to claim 10, wherein, based on the determined location and client grade, determining whether to send a notification message to the client mobile terminal to allow the client mobile terminal to provide a user interface to the user comprises:
in response to determining that the client mobile terminal is outside or inside the vehicle and that the client grade is a vehicle owner grade, sending a notification message to the client mobile terminal to allow the client mobile terminal to provide the user with a user interface for accessing an interface displaying an option menu related to the vehicle.

19. The electronic device according to claim 18, further comprising:
receiving a query command or control command input by the user after the user accesses the interface displaying the option menu through the user interface; and
based on the query command or the control command, providing relevant information obtained based on the query command to the client mobile terminal, or controlling the vehicle to perform a corresponding action according to the control command.

20. The electronic device according to claim 10, wherein, based on the determined location and client grade, determining whether to send a notification message to the client mobile terminal to allow the client mobile terminal to provide a user interface to the user comprises:
in response to determining that the client mobile terminal is outside the vehicle and that the client grade is not a vehicle owner grade, terminating communication with the client mobile terminal.

21. The electronic device according to claim 10, wherein, based on the determined location and client grade, determining whether to send a notification message to the client mobile terminal to allow the client mobile terminal to provide a user interface to the user comprises:
in response to determining that the client mobile terminal is inside the vehicle and the client grade is the owner grade or the passenger grade, sending a notification message to the client mobile terminal to allow the client mobile terminal to provide the user with a user interface for accessing an interface displaying an option menu related to interior devices of the vehicle.

22. The electronic device according to claim 21, further comprising:
receiving a query command or control command input by the user after the user accesses the interface displaying the option menu through the user interface; and
based on the query command or the control command, providing relevant information obtained based on the query command to the client mobile terminal or controlling the vehicle to perform a corresponding action according to the control command.

23. The electronic device according to claim 21, further comprising:
providing an onboard display of a user interface to the user through a display device of the vehicle;
displaying an option menu related to interior devices of the vehicle in response to the user clicking the onboard display of the user interface; and
based on the query command or control command input by the user on the interface displaying the option menu, feeding back to the user relevant information obtained based on the query command, or performing a corresponding action according to the control command.

24. The electronic device according to claim 10, wherein detecting a client mobile terminal within a predefined distance range of the vehicle comprises:
detecting the client mobile terminal within the predefined distance range of the vehicle based on near-field connection technology or Global Navigation Satellite System (GNSS) high-precision positioning technology, wherein the near-field connection technology includes one or more of Bluetooth connection technology, Ultra-Wide Band (UWB) connection technology, or Wi-Fi connection technology.

25. The method of claim 1, wherein the client grade includes a vehicle owner grade and a passenger grade.

26. The method of claim 1, wherein detecting a location of the client mobile terminal comprises:
detecting the location of the client mobile terminal relative to the vehicle based on GNSS high-precision positioning technology.

27. The method of claim 2, wherein the option menu is one of an overlay menu and a multi-level menu.
